(19) United States
(12) Patent Application Publication
(10) Pub. No.: US 2025/0073627 A1
(43) Pub. Date: Mar. 6, 2025

(54) Air Filter for Construction Projects

(71) Applicant: Chris Donatelli, Wayne, IL (US)

(72) Inventor: Chris Donatelli, Wayne, IL (US)

(21) Appl. No.: 18/241,476

(22) Filed: Sep. 1, 2023

(51) Int. Cl. B01D 46/00; B01D 46/10; B01D 46/62

(52) U.S. Cl. CPC B01D 46/0005; B01D 46/10; B01D 46/62; B01D 2265/024; B01D 2279/50

(57) ABSTRACT

An air filter suitable for temporary or interim use is configured to be removeably affixed over or inside the return air duct boot of a building under construction. In one embodiment, the air filter comprises a piece of air filtration material having a resilient, shaped, stretchable perimeter and further comprising integral magnetic strips suitable to adhere the invention to a metal return air duct boot. In a preferred embodiment, one or more layers of air filtration material are affixed to a shaped frame and may further comprise a plurality of magnets and billowable fabric to retain the invention sealably in position in the return air duct boot.

### BACKGROUND OF THE INVENTION

Construction activities for buildings can be messy and dusty. In most construction activities, wood is cut, producing saw dust. Drywall is cut and joint compound is applied and sanded, producing in general extensive dust. Drywall and joint compound are typically installed after ductwork is installed and is usually finished after the building has been sealed from the outside elements. Sealing the building from the outside elements permits the heating or air conditioning units to be used during construction. This is useful to help acclimatize building products to the controlled temperature and/or humidity of the building once completed. However, this can result in dust and debris being taken into the heating and air conditioning duct work and air handlers if the air is not first filtered.

Return air ducts and boots can be of a specific, commercially available size or can be custom made on the work site. Typically, return air ducts or return air duct boots are made from a metal, such as sheets of galvanized steel, to which magnets will adhere. Return air ducts and their boots for use in buildings are generally associated with the heating and air conditioning units they serve. During construction, air-borne, ambient dust and debris levels can be high. The high levels of ambient dust and debris make it useful to filter those materials out from the air before the air reaches the return air ducts since many dusts, such as gypsum dust, can damage the heating, ventilation and air conditioning (“HVAC”) system of a building. Further, if dust and debris enter the return air duct, it can stick to the interior walls of the ducts and reduce the efficiency of the heat and air system. Thus, even before the building is occupied, the quality and longevity of the HVAC system can be compromised. To prevent this, these materials should be filtered out during the construction phase. For this, it is useful to place a filter at the entry of each return air duct boot of a building to prevent construction dust from entering the duct work.

There are few standard-sized temporary air filters suitable for use during construction. Standard air filters are not made to trap construction dust since that type of dust does not routinely or typically occur in the same form or amount as during construction. Further, while standard size return air ducts and boots are common, many are custom sized. To complicate the matter, standard and custom size return air duct boots may not be square. And while most HVAC systems employ an air filter positioned in the air flow stream immediately prior to the entry of the air into the HVAC system, that filter cannot protect the air ducts. Given the amount of dust produced, and given the amount of dust produced during construction, multiple air filters would be needed during construction, with replacement needed potentially many times. These standard air filters are not reusable. It can be difficult, expensive and ineffective to use any filter protection not designed for the specific purpose of trapping construction dust prior to entry into the return air duct and boot. However, it is more costly not to make efforts to protect the HVAC system from dust and debris during construction.

Critically, the failure to take preventative measures may cause damage to a building's HVAC system the owner may not become aware of for years.

There is a need for an air filter suitable to be used with different sized and/or irregularly shaped return air duct boots and which can conform to the specific size and shape of a return air duct boot. There is a further need for an air filter which can be fitted to a return air duct boot by the use of a frame on which an air filter is adhered. There is a further need for an air filter system in which two or more air filters may be fitted to a frame which can be secured to a return air duct boot. There is a further need for an inexpensive, reusable temporary air filter, singly or in series, to protect the HVAC system of a building under construction. The present invention meets these needs.

### BRIEF DESCRIPTION OF THE INVENTION

In an embodiment, the invention comprises an air filtration material in the form of a woven or pressed fiber fabric on which further comprises a flexible perimeter. The flexible perimeter may commonly be comprised of affixed flexible magnets to take advantage of air ducts boots being made typically of a metal to which magnets adhere. The use of flexible magnetic strips allows the invention to contour to most irregularities in the return boot having an approximately rectangular shape. A plurality of magnetic strips are affixed to and retained within the perimeter of the flexible filtration material. The plurality of magnetic strips are sized to allow the invention to be removeably fitted within a variety of standard and custom return air duct boots. The number and positioning of the plurality of magnetic strips of the invention is set to allow the invention to fit tightly within the interior perimeter of the return air duct boot in which it is placed. During construction, the filter can easily be replaced and the dirty filter is cleaned and reused.

In a preferred embodiment, a resilient frame sized to fit partially into and generally around the mouth of a return air duct boot has affixed to an entire interior perimeter of the resilient frame an air filtration material. A plurality of magnet strips are disposed proximate to the perimeter of the resilient frame at the attachment line of the air filtration material to ensure a tight seal between the air filtration material and the interior wall of the return air duct boot. Magnetic strips are affixed to the air filtration material to create a seal between the air filtration material and the interior walls of the return air duct boot.

In an alternate preferred embodiment, two or more filters may be disposed serially on the resilient frame and used within a return air duct boot. In general, embodiments of the preferred embodiment may be cleaned, such as by vacuuming, tapping the invention against a hard surface to dislodge dust and debris or by washing/spraying the air filtration material with water.

In some applications of the invention, a sensor, marker or other reminder may be incorporated into or onto the invention to remind workers to clean or change out the invention.

In a preferred embodiment, when construction has been completed and the dust returns back to normal levels, the invention is removed. In other embodiments, the invention may continue to be used to continue efforts to maintain the health of the return air duct system.

### BRIEF DESCRIPTION OF THE DRAWINGS

FIG. 1 depicts an exemplary air filtration material usable for the first embodiment.

FIG. 2 depicts the exemplary air filtration material of FIG. 1 on which are disposed a plurality of magnet strips.

FIG. 3 depicts a view of a portion of perimeter of the air filtration material being closed to seal a magnet strip in place.

FIG. 4 depicts an isometric view of the assembled air filter from FIG. 1.

FIG. 5 depicts an isometric view of the frame of the preferred embodiment of the invention.

FIG. 6 depicts a side view of the frame of FIG. 5.

FIG. 7 depicts a cut-away side view of the frame of FIG. 5.

FIG. 8 depicts a back view of the frame of FIG. 5.

FIG. 9 depicts an isometric view of the air filtration fabric of the preferred embodiment further depicting cut lines and fold lines of the air filtration fabric.

FIG. 10 depicts the air filtration fabric of FIG. 9 showing the air filtration fabric cut and folded for affixing to the frame of FIG. 5.

FIG. 11 depicts an isometric rear view of the air filtration fabric of FIG. 9 affixed in place to the frame of FIG. 5.

FIG. 12 depicts a detail of a portion of frame of the preferred embodiment to which a portion of the ait filtration fabric is affixed.

FIG. 13 depicts an isometric view of the air filtration fabric used as a second layer of the preferred embodiment further showing fold lines and cut lines as dotted lines.

FIG. 14 depicts the flap of the preferred embodiment.

FIG. 15 depicts an isometric view of the assembled preferred embodiment.

FIG. 16 depicts an isometric view of a magnet strip used in the preferred embodiment.

FIG. 17 depicts a side view of the magnet strip used in the preferred embodiment.

FIG. 18 depicts a side view of the magnet strip showing the ability to flex the magnet strip.

FIG. 19 depicts a side view of the preferred embodiment further depicting a magnet strip affixed thereto.

FIG. 20 depicts an exploded view of the preferred embodiment proximate to an exemplary return air duct boot.

FIG. 21 depicts an isometric view of a standard return air duct boot.

FIG. 22 depicts details of the secondary air filtration of the preferred embodiment.

### DETAILED DESCRIPTION OF THE INVENTION

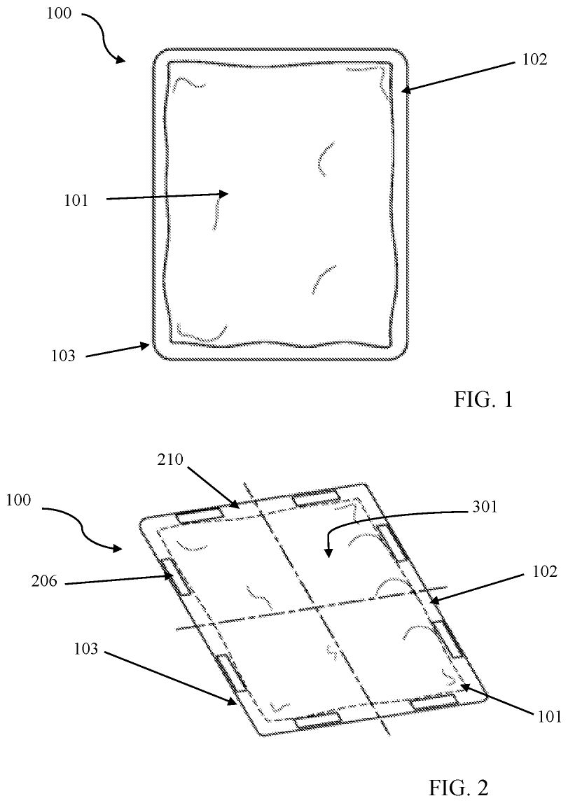

Referring to FIG. 1, the first embodiment 100 comprises a sheet of air filtration material 101. For the purposes of the first embodiment 100, air filtration material 101 should be washable or otherwise cleanable. Air filtration material 101 in this embodiment is rectangular, although any shape suitable for use in a return air duct boot is permitted. The four sides of the rectangular air filtration material 101 are referred to together as the perimeter 102. Perimeter 102 is generally identified as an integral, un-demarcated 1 inch to 1.5 inch band of air filtration material 101 bounding the outer edge of air filtration material 101. Referring also to FIG. 2, air filtration material 101 has an edge 103. Edge 103 refers to a sizeless outer extremity of air filtration material 101.

Referring still to FIG. 2, first embodiment 100 is constructed by disposing a plurality of magnetic strips 206 along the entire perimeter 102 of the air filtration material 101. Ideally, magnetic strips 206 will be thin and flexible. Preferably, magnetic strips 206 may be commercially available flexible magnets having a width of ⅜ths of one inch to ⅗ths of one inch and further having a thickness of approximately 1/16th of one inch. Magnetic strips 206 may be in the form of a ribbon of tape one or more yards long and may be cut to desired lengths, typically 3 inches to 5 inches, more or less.

Referring to a single edge 103 in FIG. 2, one or more magnetic strips 206 are affixed proximate to and parallel to edge 103 and, further, within perimeter 102. Each magnetic strip 206 may be affixed by any suitable method that allows the magnetic strip 206 and air filtration material 101 to stretch generally and apart from those parts of air filtration material 101 at which each magnetic strip 206 is affixed. Commonly, an adhesive suitable to affix pieces of cloth together is used. This process is repeated on each of the four sides of edge 103 until magnetic strips 106 are affixed within all four sides of rectangular air filtration material 101.

Referring also to FIG. 3, a plurality of magnetic strips 206 are retained on the first embodiment 100 within perimeter 102 by folding over the portion of the perimeter 102 of air filtration material 101 on which each magnetic strip 206 is disposed and sealing the fold. The fold may be sealed by sewing, the application of an adhesive or by using strips of hook and loop materials. The sealing method may be referred to as the creation of a “seam” as that term is commonly used. Again, this process is repeated along the entire perimeter 102 until magnetic strips 206 are usably disposed in the entire perimeter 102.

As depicted in FIG. 2, a space 210 is disposed between each piece of magnetic strip 206 disposed in the perimeter 102. The finished first embodiment 100 has a usable length and a width defined generally as the portion of the air filtration material 101 between the seams created by the sealing of the fold of the perimeter 102 on the first embodiment 100. This length and width constitute the working area 301 of the first embodiment 100. The space 210 between magnetic strips 206 permits the first embodiment 100 to be used in return air duct boots having a height and/or width equal to or smaller than the working area 301 of the first embodiment 100. Space 210 may be reduced in size by positioning magnetic strips 206 closer to each other during use.

As depicted in FIG. 1, the perimeter 102 of the first embodiment 100 may take the form of a rectangle, in that many air ducts and boots may take that shape. Circular ducts are also used, and so the first embodiment 100 and perimeter 102 may be circular in shape. In some embodiments, magnetic strips 206 may be more flexible, depending on the shape and form of the return air duct boot. A more flexible magnetic strip 206 may be suitable for use to permit the perimeter 102 of the first embodiment 100 to take the form of the return air duct boot.

Each magnetic strip 206 is used to form a seal between the perimeter 102 within the interior conduit of a return air duct boot. Typically, the length of the perimeter 102 will be slightly larger than the interior perimeter or circumference of the return air duct boot. More specifically, the length and width of the working area 301 will typically be proportional to the length and width of the return air duct boot but slightly larger. In use, the perimeter 102 of the first embodiment 100 is compressed slightly to fit within the perimeter of the air duct boot. The magnetic strips 206 are then positioned sealably against the interior walls of the return air duct boot so as to prevent dust and debris from being drawn into the heating and air conditioning system of the building during use.

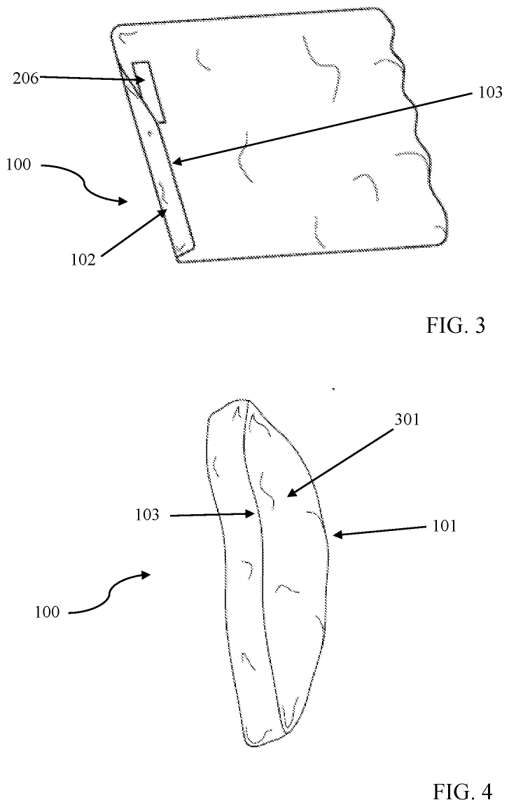

Referring to FIG. 4, an isometric view of the first embodiment 100 is depicted. As stated, the working area 301 of air filtration material 101 is typically larger than the cross-sectional size of the air duct boot in which it is used. This causes the air filtration material 101 to billow during use to make better functional use of the working area 301 used for filtering dust and debris from the air. This increases the effectiveness of the filter.

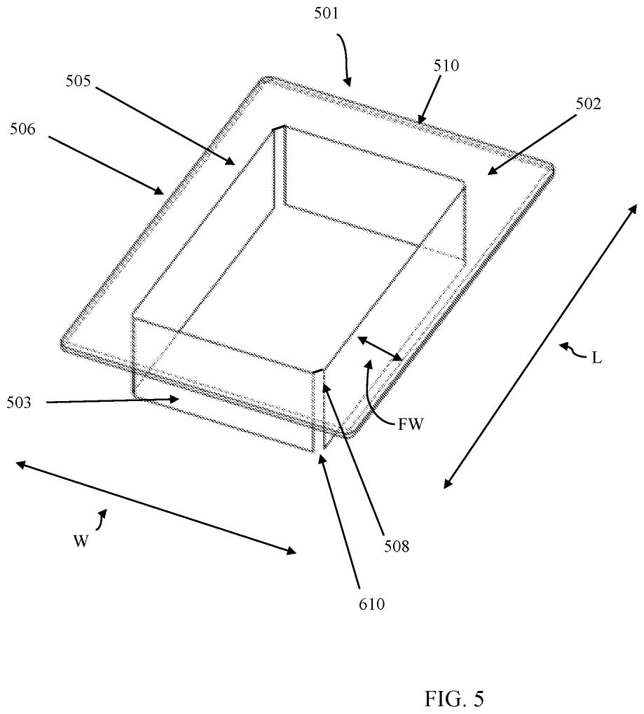

Referring now to FIG. 5, a frame 501 used in the preferred embodiment of the invention is depicted. Frame 501 is rectangular in shape and has a length L and a width W. Frame 501 comprises a flange 502 suitable to be disposed against a drywall panel, such as Sheetrock®, behind which a return air duct boot is disposed. As depicted in FIG. 5, the flange 502 of frame 501 further comprises an inner perimeter 505 and an outer perimeter 506. Frame 501 may be made from one of a variety of suitable materials, such as metal, plastic, pressed cardboard, fiberboard or other rigid material having strength sufficient to hold air filtration materials in place during use and, preferably, during repeated use.

Flange 501 has a flange width FW. Depending on the size of the return air duct boot in which the preferred embodiment is used, flange width FW may be approximately ½ inch to 1½ inches, more or less. In an embodiment, flange 502 may further comprise one or more tear strips 510. A single sample tear strip 510 is depicted in FIG. 5. Typically, if frame 501 is made of a suitable material, one or more tear strips 510 may be disposed along the perimeter of flange 502. By tearing flange 502 along a tear strip 510, a flange 502 may be resized to fit around obstructions proximal to the return air duct boot that may interfere with placing the preferred embodiment into position.

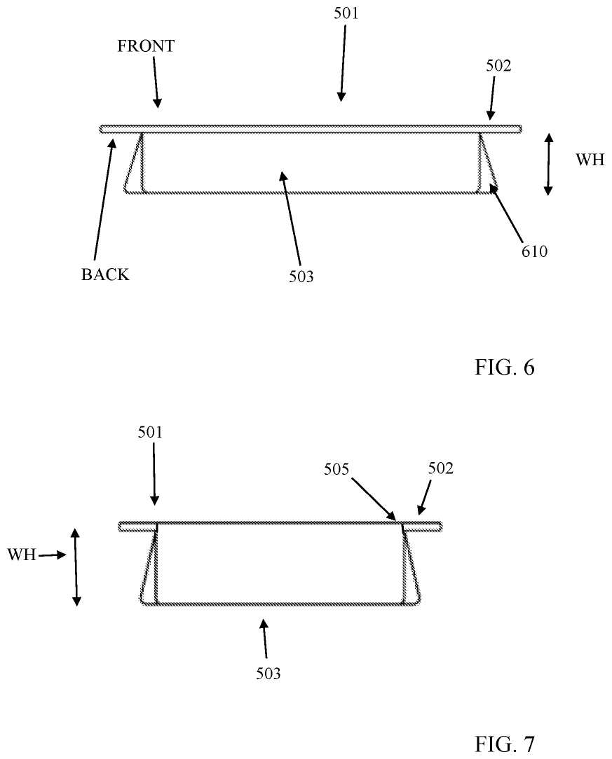

Referring still to FIG. 5 and also to FIG. 6, frame 501 has disposed approximately orthogonally along the entire inner perimeter 505 a wall 503 projecting generally orthogonally away from flange 501. Wall 503 projects inwardly in the direction of the expected air flow through the preferred embodiment and into a return air duct boot during use. In the preferred embodiment, wall 503 has four corners 508 corresponding to the four corners of inner perimeter 505. Wall 503 may preferably be contiguous along the entire inner perimeter 505 or may be notched or gapped at one or more of each of the corners 508 of wall 503, such as shown by notch 610 depicted in FIG. 6. One or more notches 610 may aid compression of walls 503 inwardly during installation of the preferred embodiment in a return air duct boot. This inward compression of walls 503 may be used to facilitate installation of the preferred embodiment into a return air duct boot by reducing the potential for a wall 503 to engage the interior wall of the return air duct boot while the preferred embodiment is installed. Still referring to FIG. 6, for the purposes of this disclosure, it is noted that frame 501 has a front, which is that side of the flange 502 disposed outward from the return air duct boot in which the preferred embodiment is used, and a back, which is that side of the flange 502 disposed in the direction of the return air duct boot in which the preferred embodiment is used.

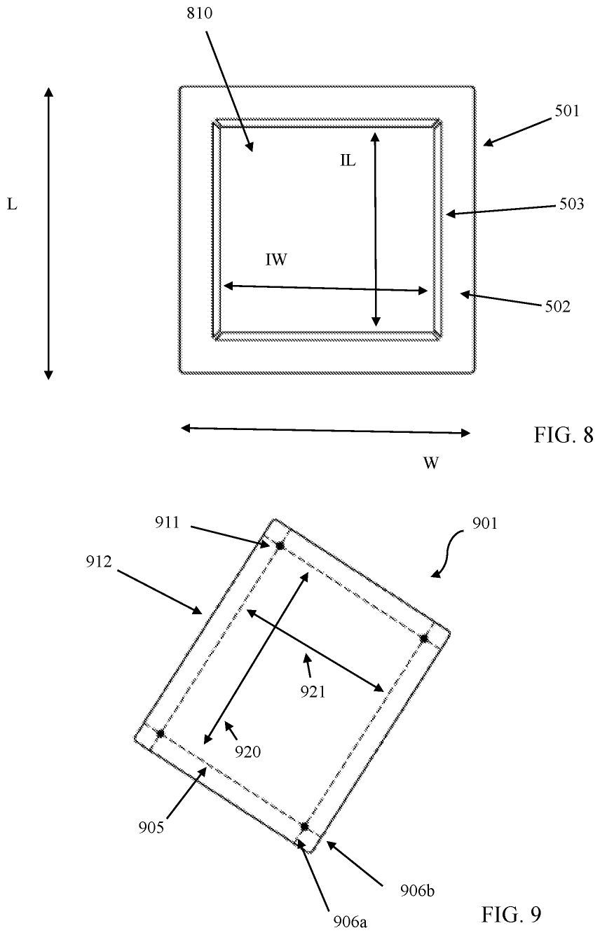

Referring also to FIG. 7, as to a cut-away view of frame 501, it is seen that wall 503 has a wall height WH approximately the same size as flange width FW, although no specific relationship between wall height WH and flange width FW is required other than to ensure the stability and functionality of the preferred embodiment. Referring further to FIG. 8, a back view of frame 501 depicts that flange 502 maintains the same flange width FW relative to the entire inner perimeter 505 of frame 501. As best depicted in FIG. 8, frame 501 forms an air conduit 810 having an interior length IL and an interior width IW. Typically, interior length IL and interior width IW are each sized ¼ inch to ⅝ inch smaller than the corresponding dimensions of the return air duct boot in which the preferred embodiment is to be used. The size of interior length IL and interior width IW depends in part on the thickness of walls 503. The thickness of walls 503 depends in part on the material from which frame 501 is made.

Referring now to FIG. 9, an isometric view of a sheet of air filtration material 901 used in the preferred embodiment is depicted. Air filtration material 901 may be comprised of a range of woven, matted or meshed materials, including combinations of woven, matted or meshed materials, such as (i) fiberglass fabrics, (ii) natural fabrics (such as cotton), (iii) synthetic fabrics (such as polyester), (iv) electrostatic fabrics, (v) HEPA filters commercially available and similar fabrics or materials. Air filtration material 901 is depicted with folding lines 905 and connection lines 906. Four folding lines 905 define a rectangular space in air filtration material 901 having an inner length 920 and inner width 921 generally equal to or slightly larger than the inner length IL and inner width IW of frame 501. The inner length 920 and inner width 921 of air filtration material 901 is sized to allow air filtration material 901 to be disposed when assembled (described below) over walls 503 of frame 501.

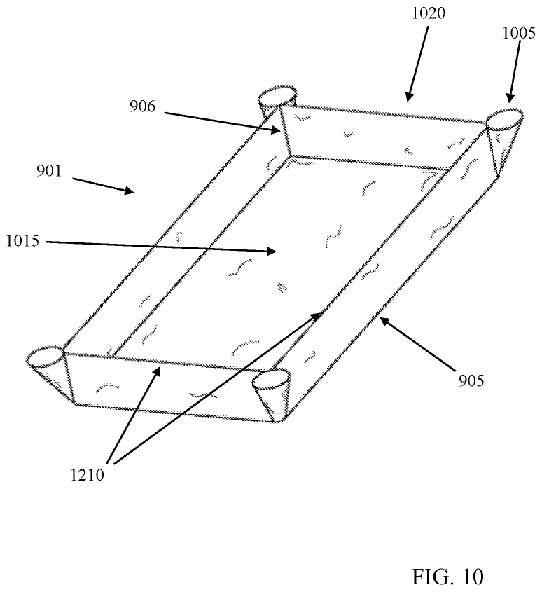

Still referring to FIG. 9, the four folding lines 905 converge at four convergence points 911 proximal to each of the four corners of air filtration material 901. From each convergence point 911, two connection lines 906 extend at a right angle relative to each other toward the edge 912 of air filtration material 901. For convenience, connection lines 906 are identified by designating an “a” connection line 906 and a “b” connection line 906. Referring further to FIG. 10, air filtration material 901 is depicted with each folding line 905 folded to create an approximately 90 degree angle at the fold, thereby creating four fabric walls 1010 by the connection of four pairs of connection lines 906a and 906b. Pairs of connection lines 906a and 906b may be connected by sewing, gluing, stapling, riveting or other suitable connection methods. Sewing or gluing are typically the simplest forms of connection.

When each pair of connection lines 906a and 906b are connection, a portion of air filtration material 901 disposed between connected pairs of connection lines 906a and 906b forms a pocket 1005, the fabric of each of which pocket 1005 is retained on air filtration material 901.

In this constructed form, air filtration material 901 is now in the form of a first filter 1020.

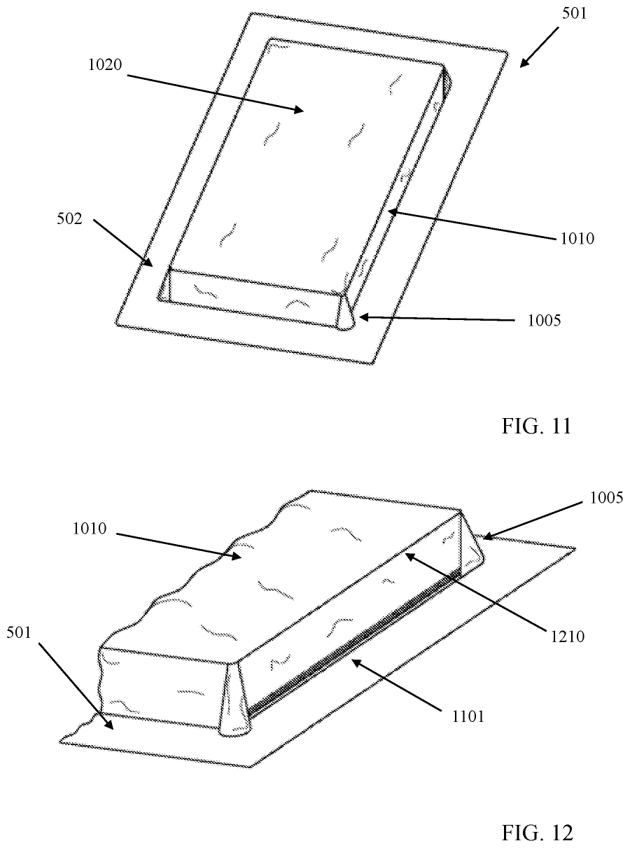

FIG. 11 depicts first filter 1020 disposed in place over and around walls 503 of frame 501. For this, the interior length IL of frame 501 is aligned with the inner length 901 of first filer 1020. This then aligns the interior width IW of frame 501 with inner width 902 of first filter 1020. Four fabric walls 1010 are then disposed over and around frame wall 503 until all edges of first filter 1020 make contact with or nearly make contact with the point at which walls 503 intersect with flange 502. Each of the four fabric walls 1010 is affixed to each of the walls 503. For the preferred embodiment, “outside” refers to the direction away from air conduit 810. Fabric walls 1010 may be affixed to walls 503 using glue, two-sided tape, rivets, hook and loop products (e.g. Velcro®) or other means. Preferably, first filter 1020 is removeably attached to frame 501 so that the filter may be removed for cleaning. As depicted in FIG. 12, a detail of first filter 1010 is depicted in position over wall 503 (not depicted) against the back of flange 502 on frame 501. In FIG. 12, a glue line 1101 is depicted to show that form of attachment.

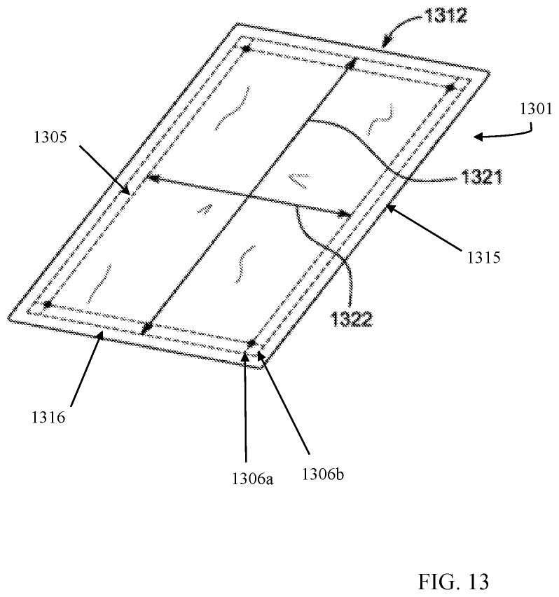

Referring to FIG. 13, an optional second filter layer is depicted. A second air filtration material 1301 comprises an edge 1312, an interior length 1321, an interior width 1322, fold lines 1305, convergence points 1311 and connection lines 1306a and 1306b generally similar to those of air filtration material 901 described relative to FIG. 9. Connection lines 1306a and 1306b of second air filtration material 1301 are joined in a manner similar to the description for making first filter 1020.

Although second air filtration material 1301 generally takes the form of air filtration material 901, second air filtration material 1301 is cut large enough to comprise additional flap material 1315 around the perimeter of second air filtration material 1301 marked by flap line 1316 also disposed generally around the perimeter of second air filtration material 1301 and set back from the perimeter sufficiently to be able to be formed into a flap when attached to first filter 1020.

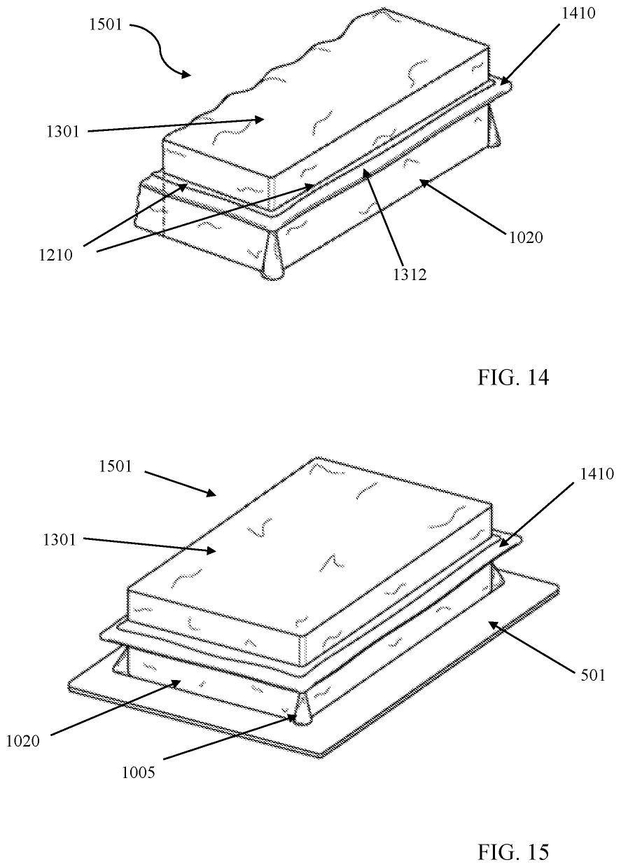

Referring to FIG. 14 and FIG. 15 together, second air filtration material 1301 has been formed into second filter 1501 in the same manner as first filter 1020 was formed. Second filter 1501 is disposed along fold lines 905 of first filter 1020. During use, air flows through the first filter 1020 within the first filter functional perimeter 1210. Second filter 1501 is affixed to first filter 1020 by folding a portion of edge 1312 into a flap, depicted as flap 1410. Flap 1410 is then attached along the entire first filter functional perimeter 1210 in a similar manner as first filter 1020 was attached to frame 501; that is, by gluing, sewing, hook and loop material, stapling, riveting or other attachment method. Again, it is preferred that second filter 1501 be removeable from first filter 1020 to facilitate cleaning.

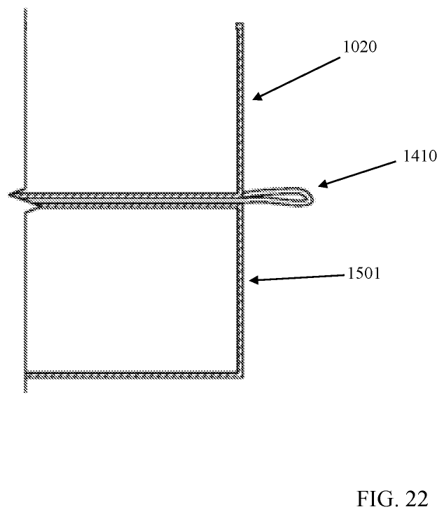

Referring to each of FIG. 12 and FIG. 15, along with a variety of attachment methods may be used to attach each of the filter materials as described herein, it is important that any attachment method be continuous along the line of attachment to prevent air flow around either of the filter materials instead of through them. This requirement identifies the function of flap 1410 as well as pockets 1005. Because return air duct boots may not be installed in a specifically rectangular shape (that is, irregular shapes may result from installation of the return air duct boot), flap 1410 and pockets 1005 are pressed between the preferred embodiment and the inside walls of a return air duct boot. Referring to FIG. 22, a flap 1410 is constructed between first filter 1020 and second filter 1501. It is depicted that flap 1410 is constructed in a manner that causes flap 1410 typically to project in a direction outward and away from air conduit 810 so as to provide a sealing effect of the first filter 1020 and second filter 1501 during use.

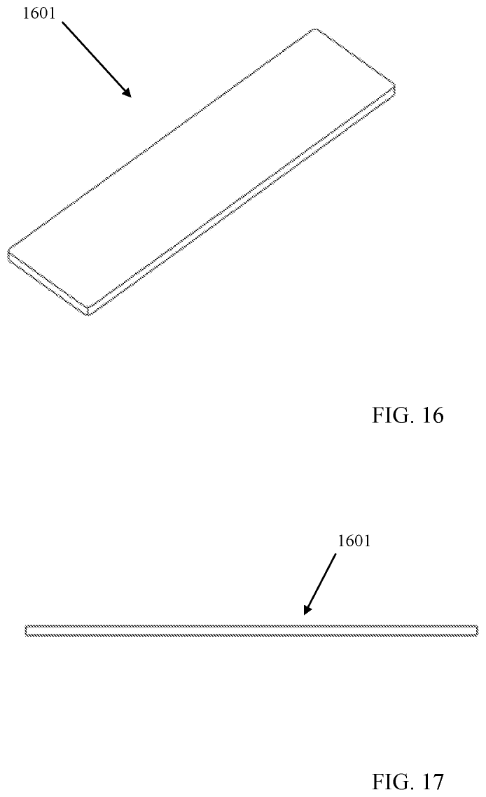

Referring now to FIG. 16 and FIG. 17, a strip magnet 1601 is depicted. Strip magnet 1601 is typically a commercially available strip magnet having a width between approximately ¼th inch and ⅝th inch and a thickness between approximately ⅛th inch and 3/16th inch. Commercial strip magnet tape may commonly be cut to a desired length for a specific application. Cutting the strip magnet may be cut by a knife, scissors or similar means.

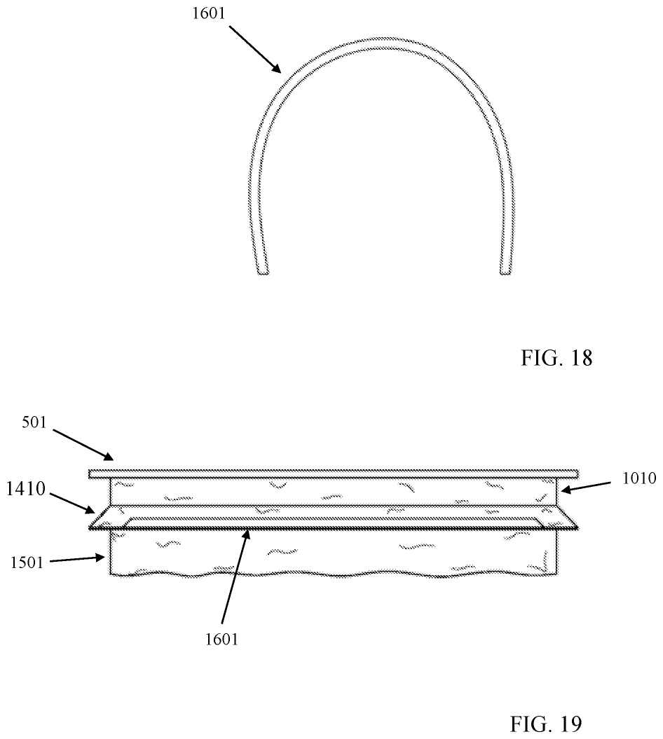

Referring now to FIG. 18, it is shown that strip magnet 1601 is flexible. Commonly, strip magnet 1601 may used which has disposed on one side an adhesive material, such as a synthetic rubber adhesive. FIG. 18 depicts a length of strip magnet 1601 curved in approximately a half circle. While the level of flexure of strip magnet 1601 does not typically reach the level depicted in FOG. 18, some flexibility of strip magnet 1601 is necessary to allow strip magnet 1601 to adhere to an uneven surface in a return air duct boot.

In the preferred embodiment and referring now to FIG. 19, a strip magnet 1601 is adhered to flap 1410. Strip magnet 1601 may be adhered by clips, staples, rivets or other suitable methods. One or more strip magnets 1601 may be affixed to each of the four sides of flap 1410 of second filter 1501. In FIG. 19, one strip.magnet 1601 is disposed along approximately the entire length on one side of the flap 1410 of second filter 1501. Alternatively, a plurality of shorter length of strip magnets 1601 may be used. In the preferred embodiment, strip magnets are used along approximately the entire length of flap 1410 around four sides of the preferred embodiment.

In alternative embodiments, strip magnets may be applied along fabric walls 1010 of first filter 1020 instead of flap 1410 or similarly along the walls of second filter 1501.

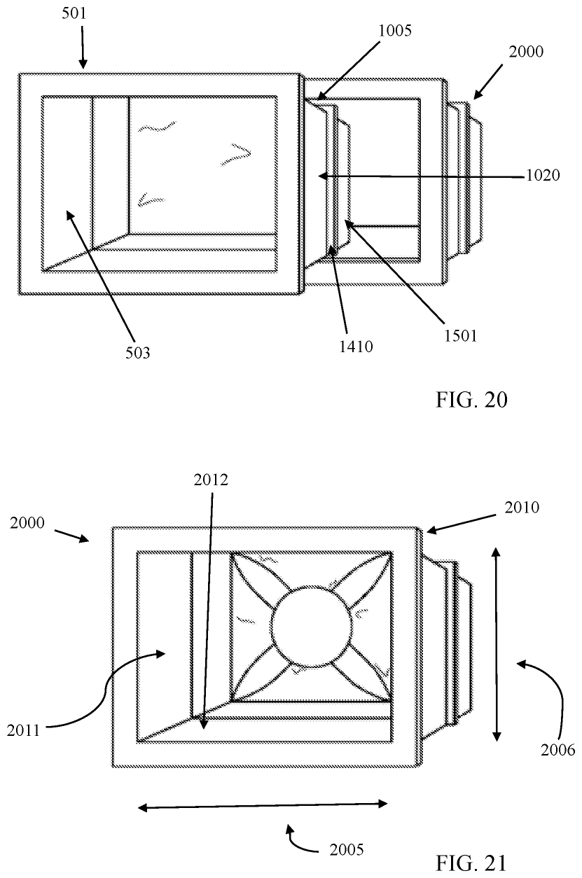

Referring to FIG. 20 and FIG. 21, a typical return air duct boot 2000 is depicted. Return air duct boot 2000 comprises an air duct boot flange 2010 which, when the return air duct boot 2000 is installed, is disposed behind a layer of drywall material and may typically be affixed to wall studs (not depicted) or ceiling joists (not depicted). Return air duct boot 2000 further comprises a return air conduit 2011 having a width 2005 and a height 2006. Return air conduit 2011 is defined typically by four interior walls 2012. Return air duct boot 2000 is commonly made from a metal, such as galvanized steel.

As depicted in FIG. 20, second filter 1501, first filter 1020, flaps 1410, strip magnets 1601 and pockets 1005 are assembled on frame 501 and are inserted into return air conduit until flange 502 is pressed against the drywall sheet covering air duct boot flange 2010 of return air duct boot 2000. The preferred embodiment is sized such that strip magnets 1601 affixed to flaps 1410 attach to interior walls 2012. Further, flaps 1410 and pockets 1005 are compressed between walls 503 and interior walls 2012. By these aspects, the preferred embodiment is retained in position in the return air duct boot 2000 until removed.

We claim:

1. An air filter for use in a return air duct boot comprising:
a sheet of air filtration material having a size and shape comparable to but larger than the size and shape of a return air duct boot;
in which the air filtration material is generally rectangular in shape;
in which the air filter further comprises a plurality of magnetic strips integrated into the air filtration material around the perimeter of the rectangular shape of the air filter;
and further in which the plurality of magnetic strips integrated into the perimeter of the air filter are positioned to be affixed magnetically to the interior walls of the return air duct boot to form a seal around the perimeter of the air filter during use.

2. The air filter for claim 1 in which spaces are disposed between adjacent pieces of the plurality of magnetic strips to permit use of the air filter in different sizes and shapes of return air duct boots.

3. The air filter of claim 1 in which the air filter is reusable.

4. An air filter for use in and over a return air duct boot comprising:
a resilient frame having the shape generally of a rectangle;
further comprising a flange having an inner perimeter and an outer perimeter in which the inner perimeter defines an air conduit;
further comprising a plurality of walls extending approximately orthogonally from the inner perimeter of the flange;
further comprising a first filter sized and shaped to fit around the plurality of walls of the frame and attached thereto sealably
and further comprises a plurality of magnetic strips affixed to the first filter such that during use the magnetic strips sealably affix the first filter to the interior walls of the return air duct boot.

5. The air filter of claim 4 in which the air filter further comprises a second filter having the size and shape of the first filter and in which the second filter is affixed to the first filter serially.

6. The air filter of claim 4 in which the first filter comprises a plurality of pockets of air filtration material suitable to help retain the air filter in position in a return air duct boot.

7. The air filter of claim 5 in which a flap of air filtration material of the second filter is disposed between the first filter and the second filter attachment to help retain the air filter in position in a return air duct boot.

8. The air filter of claim 4 in which the frame of the air filter further comprises tear strips on the flange.

9. The air filter of claim 4 in which the first filter may be removed from the frame and cleaned for reuse.

10. The air filter of claim 5 in which the first filter and the second filter may be removed from the frame and cleaned for reuse.

11. The air filter of claim 4 in which a notch is disposed between each wall of the plurality of walls of the frame and the wall proximate to said wall.
